(19) United States
(12) Patent Application Publication
(10) Pub. No.: US 2023/0247939 A1
(43) Pub. Date: Aug. 10, 2023

(54) SYSTEMS AND METHODS FOR DETERMINING MATERIAL SPILL

(71) Applicant: Deere & Company, Moline, IL (US)

(72) Inventors: Nathan R. Vandike, Geneseo, IL (US); Bhanu Kiran Reddy Palla, Bettendorf, IA (US)

(21) Appl. No.: 17/584,986

(22) Filed: Jan. 26, 2022

(51) Int. Cl. A01D 41/127; G06T 7/00; A01D 41/12

(52) U.S. Cl. CPC A01D 41/1275; A01D 41/1217; G06T 7/0004

(57) ABSTRACT

A mobile machine includes a material receptacle configured to hold a material and a material spill sensor configured to detect a characteristic indicative of a material spill characteristic and to generate a sensor signal based on the detected characteristic. The mobile machine further includes a control system configured to determine the material spill characteristic based on the sensor signal. In some examples, the control system is configured to generate an action signal to control an action of the mobile machine based on the determined material spill characteristic.

### FIELD OF THE DESCRIPTION

The present description relates to mobile agricultural machines. More specifically, the present description relates to mobile agricultural machines that carry a material, such as a crop material.

### BACKGROUND

There are many different types of mobile agricultural machines. Some of these different mobile agricultural machines transport material, such as harvested crop material. These mobile agricultural machines include material receptacles that receive and hold material.

One example agricultural operation is an agricultural harvesting operation. An agricultural harvesting operation can include the use of multiple different mobile agricultural machines. For example, an agricultural harvesting operation may include the use of an agricultural harvesting machine, and one or more material transport machines. The agricultural harvesting machine may include a crop material receptacle, such as an on-board material storage tank. The one or more material transport machines may pull material receptacles, such as a material cart or a trailer.

As the agricultural harvester harvests and processes crop material, some of the crop material, such as grain, may be conveyed to and stored within the on-board material receptacle of the agricultural harvester. The stored crop material can be transported to material transport machines via a conveyance system, such as a chute and associated auger.

The discussion above is merely provided for general background information and is not intended to be used as an aid in determining the scope of the claimed subject matter.

### SUMMARY

A mobile machine includes a material receptacle configured to hold a material and a material spill sensor configured to detect a characteristic indicative of a material spill characteristic and to generate a sensor signal based on the detected characteristic. The mobile machine further includes a control system configured to determine the material spill characteristic based on the sensor signal. In some examples, the control system is configured to generate an action signal to control an action of the mobile machine based on the determined material spill characteristic.

Example 1 is a mobile machine comprising:
a frame;
ground engaging elements configured to support the frame above a surface of a worksite;
a material receptacle configured to hold a material;
a material spill sensor configured to detect a characteristic indicative of a material spill characteristic and to generate a sensor signal based on the detected characteristic; and
a control system configured to determine the material spill characteristic based on the sensor signal.

Example 2 is the mobile machine of any or all previous examples, wherein the control system is configured to generate action signals to control an action of the mobile machine based on the determined material spill characteristic.

Example 3 is the mobile machine of any or all previous examples, wherein the control system generates the action signals to control one or more of:
a material transfer subsystem to initiate a material transfer operation;
a steering subsystem to adjust a heading of the mobile machine;
a propulsion subsystem to adjust a speed of the mobile machine; and
an interface mechanism to surface an indication of the material spill characteristic.

Example 4 is the mobile machine of any or all previous examples, wherein the material spill sensor comprises an imaging system configured to capture an image of an area outside of the material receptacle, the mobile machine further comprising:

an image processor configured to identify material in the area outside of the material receptacle based on the image.

Example 5 is the mobile machine of any or all previous examples, wherein the material spill sensor comprises an electromagnetic radiation (ER) sensor configured to receive electromagnetic radiation that travels through an area outside of the material receptacle and to generate the sensor signal based on electromagnetic radiation received by the ER sensor.

Example 6 is the mobile machine of any or all previous examples, wherein the material spill sensor comprises an audible/acoustic sensor configured to detect a noise caused by contact between the material and a surface outside of the material receptacle and to generate the sensor signal based on the detected noise.

Example 7 is the mobile machine of any or all previous examples, wherein the material spill sensor comprises a contact sensor disposed, at least partially, in a location outside of the material receptacle and configured to detect contact with the material and to generate the sensor signal based on the detected contact.

Example 8 is the mobile machine of any or all previous examples, wherein the material spill sensor comprises a mass sensor configured to detect a mass of the material in the material receptacle and generate the sensor signal based on the detected mass.

Example 9 is the mobile machine of any or all previous examples, wherein the control system is configured to determine, as the material spill characteristic, one or more of an occurrence of material spill and an amount of material spilled based on the sensor signal.

Example 10 is the mobile machine of any or all previous examples, wherein the control system is configured to determine one or more of a location of the material spillage at the worksite based on the sensor signal and location data indicative of a location of the mobile machine at the time the characteristic was detected and a location of the material spillage relative to the mobile machine based on the sensor signal and arrangement characteristics of the material spill sensor.

Example 11 is a computer-implemented method comprising:
detecting, with a material spill sensor, a characteristic indicative of a material spill characteristic;
generating a sensor signal based on the detected characteristic;
determining the material spill characteristic based on the sensor signal; and
generating an action signal based on the determination of the material spill characteristic.

Example 12 is the computer-implemented method of any or all previous examples, wherein detecting, with the material spill sensor, the characteristic indicative of the material spill characteristic comprises:

obtaining an image with an imaging system on a mobile machine of an area outside of a material receptacle of the mobile machine.

Example 13 is the computer-implemented method of any or all previous examples, wherein detecting, with the material spill sensor, the characteristic indicative of the material spill characteristic comprises:

receiving, with an electromagnetic radiation (ER) sensor, electromagnetic radiation that travels through an area outside of a material receptacle of a mobile machine.

Example 14 is the computer-implemented method of any or all previous examples, wherein detecting, with the material spill sensor, the characteristic indicative of the material spill characteristic comprises:

detecting, with an audible/acoustic sensor, a noise caused by contact between the material and a surface outside of a material receptacle of a mobile machine.

Example 15 is the computer-implemented method of any or all previous examples, wherein detecting, with the material spill sensor, the characteristic indicative of the material spill characteristic comprises:

detecting, with a contact sensor disposed outside of a material receptacle of a mobile machine, contact with the material.

Example 16 is the computer-implemented method of any or all previous examples, wherein detecting, with the material spill sensor, the characteristic indicative of the material spill characteristic comprises:

detecting, with a mass sensor, a mass of material within a material receptacle of a mobile machine.

Example 17 is the computer-implemented method of any or all previous examples, wherein determining the material spill characteristic based on the sensor signal comprises:

determining one or more of occurrence of material spill and an amount of material spilled out of a material receptacle of a mobile machine based on the sensor signal.

Example 18 is the computer-implemented method of any or all previous examples, wherein determining the material spill characteristic based on the sensor signal comprises:

determining one or more of a geographic location of the spillage of material out of a material receptacle of a mobile machine based on the sensor signal and location data indicative of a location of the mobile machine at the time the characteristic was detected and a location of the spillage of material out of the material receptacle relative to the mobile machine based on the sensor signal and arrangement characteristics of the material spill sensor.

Example 19 is an agricultural system comprising:
a material spill control system configured to:
obtain one or more sensor signals indicative of one or more material spill characteristics;
determine the one or more material spill characteristics based on the one or more sensor signals; and
generate an action signal to control an action of the agricultural system based on the determination of the one or more material spill characteristics.

Example20 is the agricultural system of any or all previous examples, wherein the one or more material spill characteristics include one or more of:
an occurrence of spillage of material out of a material receptacle of a mobile machine;
a location of the spillage of material out of the material receptacle of the mobile machine; and
an amount of material spilled out of the material receptacle of the mobile machine.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic illustration showing one example of a mobile agricultural machine.

FIGS. 2A-2B are partial pictorial, partial schematic illustrations showing examples of mobile material transport machines.

FIG. 2C is a pictorial illustration showing one example of a material transfer operation between mobile machines.

FIG. 3 is a block diagram of one example of an agricultural system architecture that includes the mobile agricultural machine(s) from the previous figure(s).

FIG. 4 is a block diagram of one example of a material spill control system in more detail.

FIG. 5 is a flow diagram showing example operations of the material spill control system illustrated in previous figures.

FIG. 6 is a block diagram of one example of the architecture illustrated in FIG. 3 deployed in a remote server architecture.

FIGS. 7-9 show examples of mobile devices that can be used in the architecture(s) shown in the previous figure(s).

FIG. 10 is a block diagram showing one example of a computing environment that can be used in the architecture(s) shown in the previous figure(s).

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

Various mobile machines, such as mobile agricultural machines, hold various materials in material receptacles. For various reasons, these materials may spill out of the material receptacles during operation of the mobile machine. For example, mobile agricultural machines involved in an agricultural harvesting operation can hold harvested crop material, such as grain, in a crop material receptacle, such as a grain tank, a grain cart, a semi-trailer, etc. The harvested grain can be transported to a grain storage facility, such as a silo or other storage area, such as a silage pit, for later use by the farmer. In other examples, the harvested grain can be transported by the mobile agricultural machine directly to a purchaser, such as a grain elevator operation.

For a variety of reasons, the harvested crop material can spill out of the crop material receptacle during operation. For instance, material spill can occur due to overfilling of the receptacle, from sudden increases or decreases in travel speed which causes material shift, sharp turning of the machine, shift in orientation of the machine, such as due to changes in terrain. It can be difficult for an operator of the mobile machine to know that material spill has occurred, the location of the material spill, and/or the level (e.g., amount) of the spillage. For instance, the operator’s view may be obscured by components of the machine, the operator may be distracted with operation of the machine, the operation of the mobile machine can drown out the noise of such spillage, if any, as well as various other reasons.

Described herein are systems and methods which provide for the detection of material spill, which can include detecting when material spill occurs, where it occurs, and the amount of material spilled. The systems and methods utilize sensor data from one or more material spill sensors, such as one or more material spill sensors disposed on the mobile machine, and based upon the sensor data determine that material spill occurred, where the material spill occurred, and/or the amount of material spilled. In some examples, action signals can be generated to control the operation of the mobile machine based upon the determination of material spill occurrence, the location of material spill, and/or the amount of material spill, for instance various control signals to control the operation of the machine, as well as to provide indications of the characteristics of material spill (e.g., occurrence, location, amount, etc.), such as alerts and/or displays.

While various examples described herein proceed with respect to agricultural harvesting and the transport of harvested crop material, such as grain, it will be appreciated that the systems and methods described herein are applicable to various other mobile machines as well as various other machine operations, for example forestry machines and forestry operations, construction machines and construction operations, as well as turf management machines and turf management operations. Additionally, it will be appreciated that the systems and methods described herein are applicable to other mobile agricultural machines and agricultural operations, for example, but not by limitation, a dry material (e.g., fertilizer, nutrient, etc.) spreader and dry material application operation (e.g., fertilizer application operation, nutrient application operation, etc.). For illustration, a dry material spreader can include a dry material receptacle that carries dry material, such as dry fertilizer, that is to be spread on the field. The dry material may spill out of the dry material receptacle during operation of the spreader.

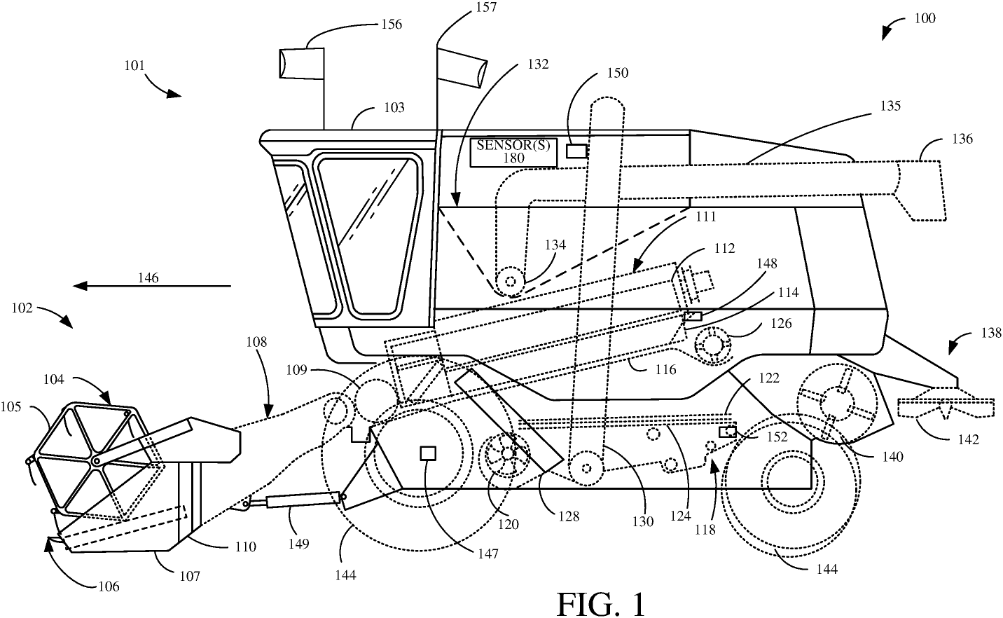

FIG. 1 is a partial pictorial, partial schematic, illustration of a mobile agricultural machine 100, in an example where mobile machine 100 is an agricultural harvester 101 (also referred to as mobile agricultural machine 101). It can be seen in FIG. 1 that mobile agricultural machine 101 illustratively includes an operator compartment 103, which can have a variety of different operator interface mechanisms for controlling agricultural harvester 101. Operator compartment 103 can include one or more operator interface mechanisms that allow an operator to control and manipulate agricultural harvester 101. The operator interface mechanisms in operator compartment 103 can be any of a wide variety of different types of mechanisms. For instance, they can include one or more input mechanisms such as steering wheels, levers, joysticks, buttons, pedals, switches, etc. In addition, operator compartment 103 may include one or more operator interface display devices, such as monitors, or mobile devices that are supported within operator compartment 103. In that case, the operator interface mechanisms can also include one or more user actuatable elements displayed on the display devices, such as icons, links, buttons, etc. The operator interface mechanisms can include one or more microphones where speech recognition is provided on agricultural harvester 101. They can also include one or more audio interface mechanisms (such as speakers), one or more haptic interface mechanisms or a wide variety of other operator interface mechanisms. The operator interface mechanisms can include other output mechanisms as well, such as dials, gauges, meter outputs, lights, audible or visual alerts or haptic outputs, etc.

Agricultural harvester 101 includes a set of front-end machines forming a cutting platform 102 that includes a header 104 having a cutter generally indicated at 106. It can also include a feeder house 108, a feed accelerator 109, and a thresher generally indicated at 111. Thresher 111 illustratively includes a threshing rotor 112 and a set of concaves 114. Further, agricultural harvester 101 can include a separator 116 that includes a separator rotor. Agricultural harvester 101 can include a cleaning subsystem (or cleaning shoe) 118 that, itself, can include a cleaning fan 120, a chaffer 122 and a sieve 124. The material handling subsystem in agricultural harvester 101 can include (in addition to a feeder house 108 and feed accelerator 109) discharge beater 126, tailings elevator 128, and clean grain elevator 130 (that moves clean grain into clean grain tank 132). Agricultural harvester 101 also includes a material transport subsystem that includes unloading auger 134, chute 135, spout 136, and can include one or more actuators that actuate movement of chute 135 or spout 136, or both, such that spout 136 can be positioned over an area in which grain is to be deposited. In operation, auger causes grain from grain tank 132 to be conveyed through chute 135 and out of spout 136. Agricultural harvester 101 can further include a residue subsystem 138 that can include chopper 140 and spreader 142. Agricultural harvester 101 can also have a propulsion subsystem that includes an engine (or other power source) that drives ground engaging elements 144 (such as wheels, tracks, etc.). It will be noted that agricultural harvester 101 can also have more than one of any of the subsystems mentioned above (such as left and right cleaning shoes, separators, etc.).

As shown in FIG. 1, header 104 has a main frame 107 and an attachment frame 110. Header 104 is attached to feeder house 108 by an attachment mechanism on attachment frame 110 that cooperates with an attachment mechanism on feeder house 108. Main frame 107 supports cutter 106 and reel 105 and is movable relative to attachment frame 110, such as by an actuator (not shown). Additionally, attachment frame 110 is movable, by operation of actuator 149, to controllably adjust the position of front-end assembly 102 relative to the surface (e.g., field) over which agricultural harvester 101 travels in the direction indicated by arrow 146, and thus controllably adjust a position of header 104 from the surface. In one example, main frame 107 and attachment frame 110 can be raised and lowered together to set a height of cutter 106 above the surface over which agricultural harvester 101 is traveling. In another example, main frame 107 can be tilted relative to attachment frame 110 to adjust a tilt angle with which cutter 106 engages the crop on the surface. Also, in one example, main frame 107 can be rotated or otherwise moveable relative to attachment frame 110 to improve ground following performance. In this way, the roll, pitch, and/or yaw of the header relative to the agricultural surface can be controllably adjusted. The movement of main frame 107 together with attachment frame 110 can be driven by actuators (such as hydraulic, pneumatic, mechanical, electromechanical, or electrical actuators, as well as various other actuators) based on operator inputs or automated inputs.

In operation, and by way of overview, the height of header 104 is set and agricultural harvester 101 illustratively moves over a field in the direction indicated by arrow 146. As it moves, header 104 engages the crop to be harvested and gather it towards cutter 106. After it is cut, the crop can be engaged by reel 105 that moves the crop to a feeding system. The feeding system move the crop to the center of header 104 and then through a center feeding system in feeder house 108 toward feed accelerator 109, which accelerates the crop into thresher 111. The crop is then threshed by rotor 112 rotating the crop against concaves 114. The threshed crop is moved by a separator rotor in separator 116 where some of the residue is moved by discharge beater 126 toward a residue subsystem. It can be chopped by a residue chopper 140 and spread on the field by spreader 142. In other implementations, the residue is simply dropped in a windrow, instead of being chopped and spread.

Grain falls to cleaning shoe (or cleaning subsystem) 118. Chaffer 122 separates some of the larger material from the grain, and sieve 124 separates some of the finer material from the clean grain. Clean grain falls to an auger in clean grain elevator 130, which moves the clean grain upward and deposits it in clean grain tank 132. Residue can be removed from the cleaning shoe 118 by airflow generated by cleaning fan 120. That residue can also be moved rearwardly in combine 100 toward the residue handling subsystem 138.

Tailings can be moved by tailing elevator 128 back to thresher 110 where they can be re-threshed. Alternatively, the tailings can also be passed to a separate re-threshing mechanism (also using a tailings elevator or another transport mechanism) where they can re-threshed as well.

FIG. 1 also shows that, in one example, agricultural harvester 101 can include a variety of sensors, some of which are illustratively shown. For example, combine 100 can include ground speed sensors 147, one or more separator loss sensors 148, a fill level sensor 150, one or more cleaning shoe loss sensors 152, one or more perception systems 156 (e.g., forward-looking systems, such as a camera, lidar, radar, etc., an imaging system such as a camera, as well as various other perception systems), and one or more material spill sensors 180. Ground speed sensor 147 illustratively senses the travel speed of combine 100 over the ground. This can be done by sensing the speed of rotation of ground engaging elements 144, the drive shaft, the axle, or various other components. The travel speed can also be sensed by a positioning system, such as a global positioning system (GPS), a dead-reckoning system, a LORAN system, or a wide variety of other systems or sensors that provide an indication of travel speed. Perception system 156 is mounted to and illustratively senses the field (and characteristics thereof) in front of and/or around (e.g., to the sides, behind, etc.) agricultural harvester 101 (relative to direction of travel 146) and generates sensor signal(s) (e.g., an image) indicative of those characteristics. For example, perception system 156 can generate a sensor signal indicative of agricultural characteristics in the field ahead of and/or around agricultural harvester 101. While shown in a specific location in FIG. 1, it will be noted that perception system 156 can be mounted to various locations on agricultural harvester 101 and is not limited to the depiction shown in FIG. 1. Additionally, while only one perception system 156 is illustrated, it will be noted that agricultural harvester 101 can include any number of perception systems 156, mounted to any number of locations within agricultural harvester 101, and configured to view any number of directions around agricultural harvester 101.

Cleaning shoe loss sensors 152 illustratively provide an output signal indicative of the quantity of grain loss by both the right and left sides of the cleaning shoe 118. In one example, sensors 152 are strike sensors which count grain strikes per unit of time (or per unit of distance traveled) to provide an indication of the cleaning shoe grain loss. The strike sensors for the right and left sides of the cleaning shoe can provide individual signals, or a combined or aggregated signal. It will be noted that sensors 152 can comprise on a single sensor as well, instead of separate sensors for each shoe.

Separator loss sensors 148 provide signals indicative of grain loss in the left and right separators. The sensors associated with the left and right separators can provide separate grain loss signals or a combined or aggregate signal. This can be done using a wide variety of different types of sensors as well. It will be noted that separator loss sensors 148 may also comprise only a single sensor, instead of separate left and right sensors.

Fill level sensor 150 illustratively provides an output indicative of the fill level of the material receptacle or grain tank 132. Fill level sensor 150 can be any of a number of different types of sensors, such as an imaging system, an electromagnetic radiation sensor, a contact sensor, as well as various other types of sensors. Additionally, while only one fill level sensor 150 is shown, in other examples agricultural harvester 101 can include more than one fill level sensor 150 including multiple different fill level sensors 150 disposed at multiple different locations.

Material spill sensors 180 provide sensor signals indicative of material having spilled out of a material receptacle, such as clean grain tank 132. One example of a material spill sensor 180 is illustratively shown in FIG. 1 as imaging system 157. Imaging system 157 has a field of view that includes an exterior of the material receptacle and can be disposed at various locations on mobile machine 100, including disposed at a location on agricultural harvester 101 outside of the material receptacle. While only one imaging system 157 is shown, it is to be understood that more than one imaging system 157 can be used. Additionally, imaging system 157 can be disposed at various locations on agricultural harvester 101. Imaging system 157 detects the presence of material within its field of view and generates a sensor signal indicative of the presence of the material within the field of view. In one example, the field of view of imaging system 157 includes designated zones in which material should not be present under normal operating conditions. Thus, in one example, the detection of material within the designated zones in the field of view of imaging system 157 indicate the occurrence of material spill. In one example, the designated zones include an exterior of the material receptacle.

In addition to imaging system 157, material spill sensors 180 can include a variety of other material spill sensors not illustratively shown in FIG. 1. For instance, material spill sensors 180 can include mass sensors configured to sense a mass of material within the material receptacle, electromagnetic radiation (ER) sensors configured to detect material spill through reception of electromagnetic radiation, contact sensors configured to detect material spill through contact between the material and the contact sensors, audible/acoustic sensors configured to detect material spill based on received audible/acoustic input, as well as various other sensors. Material spill sensors 180 will be discussed in greater detail below.

It will be appreciated that agricultural harvester 101 can include a variety of other sensors not illustratively shown in FIG. 1. For instance, agricultural harvester 101 can include residue setting sensors that are configured to sense whether agricultural harvester 101 is configured to chop the residue, drop a windrow, etc. They can include cleaning shoe fan speed sensors that can be configured proximate fan 120 to sense the speed of the fan. They can include threshing clearance sensors that sense clearance between the rotor 112 and concaves 114. They can include threshing rotor speed sensors that sense a rotor speed of rotor 112. They can include chaffer clearance sensors that sense the size of openings in chaffer 122. They can include sieve clearance sensors that sense the size of openings in sieve 124. They can include material other than grain (MOG) moisture sensors that can be configured to sense the moisture level of the material other than grain that is passing through agricultural harvester 101. They can include machine settings sensors that are configured to sense the various configured settings on agricultural harvester 101. They can also include machine orientation sensors that can be any of a wide variety of different types of sensors that sense the orientation of agricultural harvester 101, and/or components thereof. They can include crop property sensors that can sense a variety of different types of crop properties, such as crop type, crop moisture, and other crop properties. The crop property sensors can also be configured to sense characteristics of the crop as they are being processed by agricultural harvester 101. For instance, they can sense grain feed rate, as it travels through clean grain elevator 130. They can sense mass flow rate of grain through elevator 130 or provide other output signals indicative of other sensed variables. Agricultural harvester 101 can include soil property sensors that can sense a variety of different types of soil properties, including, but not limited to, soil type, soil compaction, soil moisture, soil structure, among others.

Some additional examples of the types of sensors that can be used are described below, including. but not limited to a variety of position sensors that can generate sensor signals indicative of a position (e.g., geographic location, orientation, elevation, etc.) of agricultural harvester 101 on the field over which agricultural harvester 101 travels or a position of various components of agricultural harvester 101 (e.g., header 104) relative to, for example, the field over which agricultural harvester 101 travels.

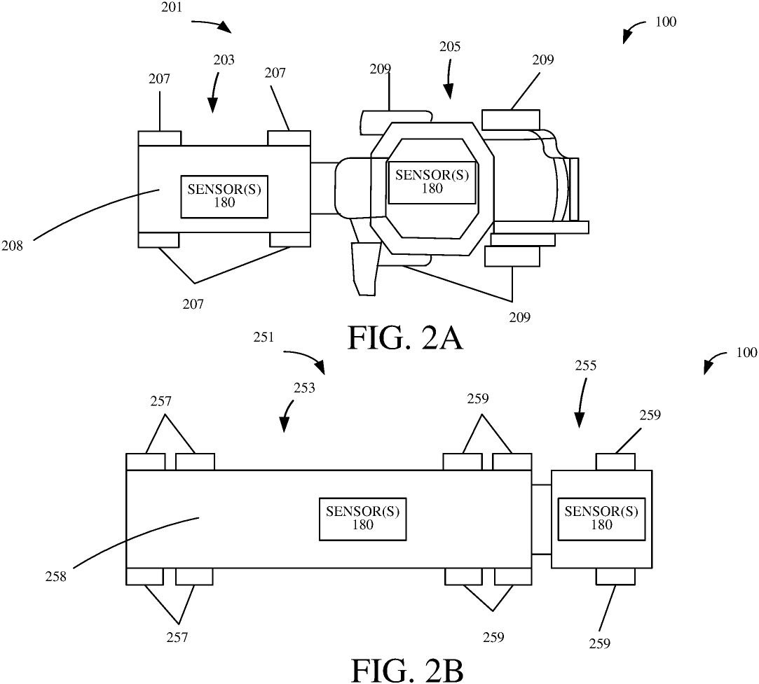

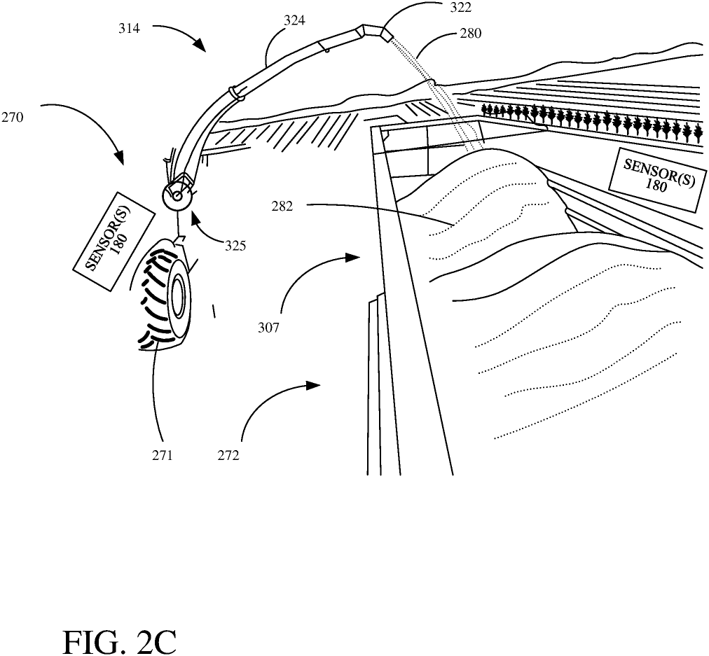

FIG. 2A is a partial pictorial, partial schematic, illustration of a mobile agricultural machine 100, in an example where mobile machine 100 is a material transport machine 201. Material transport machine 201 includes a towing vehicle 205 that tows a mobile material receptacle implement 203. In FIG. 2A, towing vehicle 205 is illustratively shown as a tractor and mobile material receptacle implement 203 is illustratively shown as a mobile grain cart. As shown in FIG. 2A, material receptacle implement 203 can include ground engagement elements 207, such as tires or tracks, a material receptacle 208, and can include one or more material spill sensors 180. Additionally, as shown in FIG. 2A, towing vehicle 205 includes ground engaging elements 209 and can include one or more material spill sensors 180. While in the example shown in FIG. 2A one or more material spill sensors 180 are shown as included on both material receptacle implement 203 and towing vehicle 205, in other examples material spill sensors 180 may only be included on one of material receptacle implement 203 or towing vehicle 205. In some examples, some material spill sensors 180 may be disposed on towing vehicle 205 while other material spill sensors 180 are disposed on material receptacle implement 203.

In operation, material receptacle implement 203 receives material, such as harvested crop material, from a mobile machine, such as agricultural harvester 101, via a material transfer subsystem, such as material transfer subsystem 314 (shown below). The material receptacle implement 203 holds the received material within material receptacle 208 and is towed by towing vehicle 205 to a desired location. One or more material spill sensors 180 can detect material spill characteristics, such as the occurrence of spillage of material out of material receptacle 208, location(s) of occurred material spill(s), and the amount(s) of material spilled. While not shown in FIG. 2A, in some examples material receptacle implement 203 can include a material transfer subsystem (such as material transfer subsystem 314 shown below), such as an unloading auger, a chute, and a spout, as well as one or more actuators for actuating the auger and/or for actuating movement of the spout or the chute, or both. In this way, the material held by material receptacle implement 203 can be offloaded therefrom through use of a material transfer subsystem. In other examples, one or more actuatable doors may be disposed on a side of material receptacle implement 203, such as the bottom side of material receptacle implement 203, which, when actuated to an open position, allow the held material to exit material receptacle 208 via gravity. Material can be offloaded from material receptacle implement 203 in other ways as well.

FIG. 2B is a partial pictorial, partial schematic, illustration of a mobile agricultural machine 100, in an example where mobile machine 100 is a material transport machine 251. Material transport machine 251 includes a towing vehicle 245 that tows a mobile material receptacle implement 253. In FIG. 2B, towing vehicle 205 is illustratively shown as a truck (e.g., semi-truck) and mobile material receptacle implement 253 is illustratively shown as a trailer (e.g., semi-trailer). As shown in FIG. 2B, material receptacle implement 253 can include ground engagement elements 257, such as tires or tracks, a material receptacle 258, and can include one or more material spill sensors 180. Additionally, as shown in FIG. 2B, towing vehicle 255 includes ground engaging elements 259 and can include one or more material spill sensors 180. While in the example shown in FIG. 2B one or more material spill sensors 180 are shown as included on both material receptacle implement 253 and towing vehicle 255, in other examples material spill sensors 180 may only be included on one of material receptacle implement 253 or towing vehicle 255. In some examples, some material spill sensors 180 may be disposed on towing vehicle 255 while other material spill sensors 180 are disposed on material receptacle implement 253.

In operation, material receptacle implement 253 receives material, such as harvested crop material, from a mobile machine, such as agricultural harvester 101 or material transport machine 201, via a material transfer subsystem, such as material transfer subsystem 314 (shown below). The material receptable implement 253 holds the received material within material receptacle 258 and is towed by towing vehicle 255 to a desired location. One or more material spill sensors 180 can detect material spill characteristics, such as the occurrence of spillage of material out of material receptacle 258, location(s) of occurred material spill(s), and the amount(s) of material spilled. While not shown in FIG. 2B, in some examples material receptacle implement 253 can include a material transfer subsystem (such as material transfer subsystem 314 shown below), such as an unloading auger, a chute, and a spout, as well as one or more actuators for actuating the auger and/or for actuating movement of the spout or the chute, or both. In this way, the material held by material receptacle implement 253 can be offloaded therefrom through use of a material transfer subsystem. In other examples, one or more actuatable doors may be disposed on a side of material receptacle implement 253, such as the bottom side of material receptacle implement 253, which, when actuated to an open position, allow the held material to exit material receptacle 258 via gravity. Material can be offloaded from material receptacle implement 253 in other ways as well.

FIG. 2C is a pictorial illustration showing one example of a material transfer operation between mobile machines. In FIG. 2C, a transferring machine 270, which could be one of the mobile machines 101 or 201, includes ground engaging elements 271 (which can be similar to ground engaging elements 144 or 207) and a material transfer subsystem 314 which itself includes auger 325, chute 324, and spout 322. Material transfer subsystem 314 transfers material 282 from transferring machine 270 to a material receptacle 307 of receiving machine 272, which could be one of the mobile machines 201 or 251. Material 282 exits spout 322 in a material stream 280 which lands in an interior of material receptacle 307.

Both transferring machine 270 and receiving machine 272 can include material spill sensors 180. During the material transfer operation the material spill sensors 180 can detect material spill characteristics, as well as various other characteristics such as a fill level of material in receiving machine 272. Ideally, material 282 is transferred from transferring machine 270 to transferring machine 272 according to a fill profile (e.g., front to back, back to front) until the transferring machine 270 is at a desired emptiness or until the material receptacle 307 of the receiving machine 272 is at a desired fill level. In some examples, material stream 280, and thus material 282, may not land in material receptacle 307 of receiving machine 272. For instance, the relative positioning or relative speed between the machines may be such that the material 282 does not land in the interior of material receptacle 307. In other examples, the machines may be correctly positioned or traveling at correct speeds, but the wind may blow the material stream 280, and thus the material 282, in an unexpected course, thus causing the material 282 to spill (e.g., land outside of material receptacle 307). In any case, the spill of material (as well as other characteristics) can be detected by material spill sensors 180 during a material transfer operation, as will be described in greater detail herein.

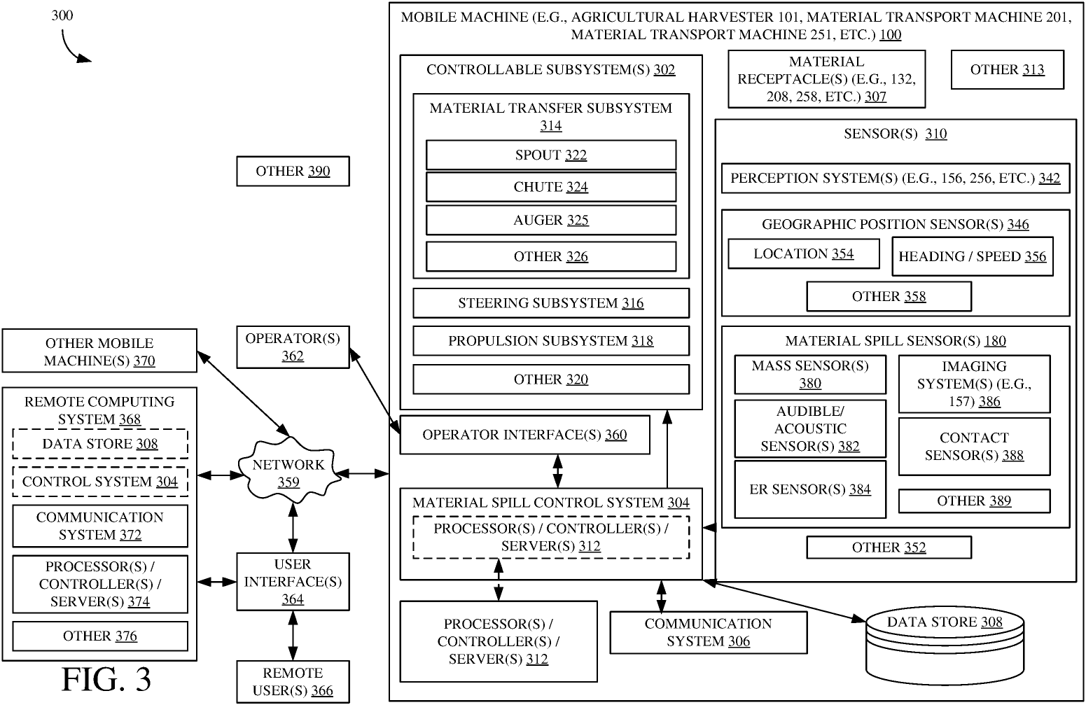

FIG. 3 is a block diagram of one example of an agricultural system architecture 300 having, among other things, a mobile machine 100 (e.g., agricultural harvester 101, material transport machine 201, material transport machine 251, etc.) configured to travel over a surface such as a worksite, for instance a field, a road, a construction site, etc. Some items are similar to those shown in FIGS. 1-2B and they are similarly numbered. FIG. 3 shows that architecture 300 includes mobile machine 100, network 359, one or more operator interfaces 360, one or more operators 362, one or more user interfaces 364, one or more remote users 366, one or more remote computing systems 368, one or more other vehicles 370, and can include other items 390 as well. Mobile machine 100 can include one or more controllable subsystems 302, material spill control system 304, communication system 306, one or more material receptacles 307, one or more data stores 308, one or more sensors 310, one or more processors, controllers, or servers 312, and it can include other items 313 as well. Controllable subsystems 302 can include material transfer subsystem 314, steering subsystem 316, propulsion subsystem 318, and can include other items 320 as well, such as other controllable subsystems, including, but not limited to those described above with reference to FIGS. 1-2B. Material transfer subsystem 314, itself, can include spout 322, chute 324, auger 325, and it can include other items 326.

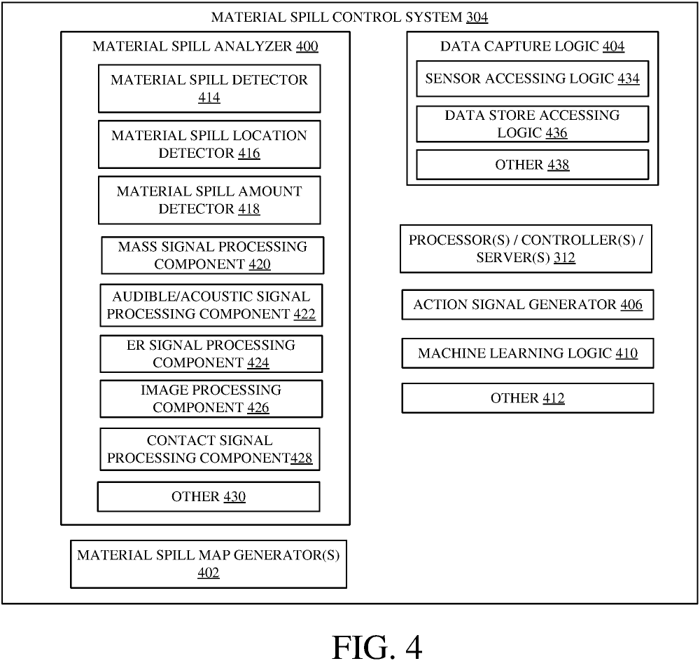

Material spill control system 304 can include one or more processors, controllers, or servers 312. Material spill control system 304 can include various other items as well, as will be described in more detail in FIG. 4. As illustrated in FIG. 3, the one or more processors, controllers, or servers 312 can be a part of control system 304 or can be a part of the mobile machine 100 and be utilized by the material spill control system 304, or can be distributed across both. Various other components of mobile machine 100 can be controlled by and/or implemented by the one or more processors, controllers, or servers 312.

FIG. 3 also shows that sensors 310 can include any number of different types of sensors that sense or otherwise detect any number of characteristics. In the illustrated example of FIG. 3, sensors 310 can include one or more perception systems 342 (such as 156 described above), one or more geographic position sensors 346, one or more material spill sensors 180, and can include other sensors 352 as well, such as, any of the sensors described above with reference to FIGS. 1-2B as well as various other sensors that can sense a variety of characteristics. Geographic position sensors 346 can include one or more location sensors 354, one or more heading/speed sensors 356, and can include other items 358.

Material spill sensors 180 can include one or more mass sensors 380, one or more audible/acoustic sensors 382, one or more electromagnetic radiation (ER) sensors 384, one or more imaging systems 386, one or more contact sensors 388, and can include various other items 389, such as various other material spill sensors.

Control system 304 is configured to control other components and systems of agricultural system architecture 300, such as components and systems of mobile machine 100 or vehicles 370. For instance, control system 304 is configured to control communication system 306. Communication system 306 is used to communicate between components of mobile machine 100 or with other systems such as vehicles 370 or remote computing systems 368 over network 359. Network 359 can be any of a wide variety of different types of networks such as the Internet, a cellular network, a wide area network (WAN), a local area network (LAN), a controller area network (CAN), a near-field communication network, or any of a wide variety of other networks or combinations of networks or communication systems.

Remote users 366 are shown interacting with remote computing systems 368, such as through user interfaces 364. Remote computing systems 368 can be a wide variety of different types of systems. For example, remote computing systems 368 can be in a remote server environment. Further, it can be a remote computing system (such as a mobile device), a remote network, a farm manager system, a vendor system, or a wide variety of other remote systems. Remote computing systems 368 can include one or more processors, controllers, or servers 374, a communication system 372, and it can include other items 376. As shown in the illustrated example, data stores 308 and control system 304, or parts thereof, can be located at remote computing system 368. For example, the data stored and accessed by various components in agricultural system architecture 300 can be remotely located in data stores 308 on remote computing systems 368. Additionally, various components of agricultural system architecture 300 (e.g., controllable subsystems 302) can be controlled by material spill control system 304 located remotely at a remote computing system 368. Thus, in one example, mobile machine 100 can be controlled remotely by material spill control system 304 located at remote computing system 368 and/or by a remote user such as by a user input received by user interfaces 364. These are merely some examples of the operation of agricultural system architecture 300.

Other vehicles 370 can include one or more other mobile machines that can operate in concert with mobile machine 100. For instance, where mobile machine 100 is an agricultural harvester, such as agricultural harvester 101, other vehicles 370 can include, for example, material transport machines, such as material transport machine 201 or 251, or both, that operate in concert with the agricultural harvester to receive and transport material harvested by agricultural harvester. Other vehicles 370 and mobile machine 100 can communicate between one another over network 259 and, in some examples, action signals or determinations, or both, generated by material spill control system 304 can be provided to other vehicles 370 for control of other vehicles 370.

FIG. 3 also shows one or more operators 362 interacting with mobile machine 100, remote computing systems 368, and vehicles 370, such as through operator interfaces 360. Operator interfaces 360 can be located on mobile machine 100, for example in an operator compartment (e.g., 103), such as a cab, or they can be another operator interface communicably coupled to various components in computing architecture 300, such as a mobile device or other interface mechanism.

Before discussing the overall operation of mobile machine 100, a brief description of some of the items in mobile machine 100, and their operation, will first be provided.

Communication system 306 can include wireless communication logic, which can be substantially any wireless communication system that can be used by the systems and components of mobile machine 100 to communicate information between items of mobile machine 100, such as among control system 304, data stores 308, sensors 310, and controllable subsystems 302. In another example, communication system 306 communicates over a controller area network (CAN) bus (or another network, such as an Ethernet network, etc.) to communicate information between those items. The information can include the various sensor signals and output signals generated by the sensos 310, action signals or determinations generated by material spill control system 304, data within data stores 308, as well as various other information. In other examples, communication system 306 can be used by the systems and components of mobile machine 100 to communicate with other items of agricultural system architecture 300, such as over network 359. Thus, in some examples, communication system 306 can be a wireless communication system, a wired communication system, or include a combination of both.

Perception systems 342 are configured to sense various characteristics relative to the environment around mobile machine 100, such as characteristics relative to the worksite (e.g., field) at which mobile machine 100 operates. Perception systems 342 can also sense characteristics of the worksite ahead of or around mobile machine 100, such that characteristics to be encountered by mobile machine 100 can be determined or identified and the operating parameters of mobile machine 100 can be adjusted (e.g., by control of one or more controllable subsystems 302). Perception systems 342 can, in one example, include imaging systems, such as cameras. In other examples, perceptions systems 342 can include lidars, radars, as well as a variety of other sensing systems.

Geographic position sensors 346 include location sensors 354, heading/speed sensors 356, and can include other sensors 358 as well. Location sensors 354 are configured to determine a geographic location of mobile machine on the worksite. Location sensors 354 can include, but are not limited to, a Global Navigation Satellite System (GNSS) receiver that receives signals from a GNSS satellite transmitter. Location sensors 354 can also include a Real-Time Kinematic (RTK) component that is configured to enhance the precision of position data derived from the GNSS signal. Location sensors 354 can include various other sensors, including other satellite-based sensors, cellular triangulation sensors, dead reckoning sensors, etc.

Heading/speed sensors 356 are configured to determine a heading and speed at which mobile machine 100 is traversing the worksite during the operation. This can include sensors that sense the movement of ground-engaging elements (e.g., wheels or tracks 144, 207, 209. 257, 259, etc.) or can utilize signals received from other sources, such as location sensors 354.

As discussed, geographic position sensors 346 can include other items 358 such as one or more inertial measurement units (IMUs) which can provide positional information relative to mobile machine 100, such as pitch, roll, and yaw data of mobile machine 100. The one or more inertial measurement units can include accelerometers, gyroscopes, and/or magnetometers.

Material spill sensors 180 detect characteristics of material spill, such as one or more of the occurrence of material spill, the location of material spill, and the amount of material spilled and can generate sensor signals indicative of the detected material spill characteristics. Material spill sensors 180, in one example, are disposed on mobile machine 100 outside of an interior of material receptacle 307 and/or are configured to detect areas and/or characteristics outside of the interior of material receptacle 307. In some examples, some material spill sensors 180 can be disposed within material receptacle 307. Material spill control system 304 determines the occurrence of spillage of material, such as spillage of crop material (e.g., grain), out of a material receptacle 307 based on sensor signals generated by material spill sensors 180. Additionally, material spill control system 304 determines an amount and location information of occurred material spill, such as location of occurred material spill at the worksite or location of material spill relative to mobile machine 100, or both, based on sensor signals generated by material spill sensors 180. The operation of material spill control system 304 will be discussed in more detail in FIG. 4. As illustrated in FIG. 3, material spill sensors 180 can include one or more mass sensors 380, one or more audible/acoustic sensors 382, one or more electromagnetic radiation (ER) sensors 384, one or more imaging system 386, one or more contact sensors 388, and can include other types of material spill sensors 389 as well.

Mass sensors 380 detect a mass (i.e., weight) of material within material receptacle 307 and generate sensor signals indicative of the mass of the material within material receptacle 307. Mass sensors 380 can include load cells, strain gauges, pressure sensors, as well as various other types of mass sensors. Mass sensors 380 can be positioned between components of mobile machine 100. For instance, mass sensors 380 can be positioned between material receptacle 307, or a frame, or other body, that supports material receptacle 307, and axle(s) of mobile machine 100, these mass sensors 380 generate a signal in response to force applied by the weight of the material receptacle 307 and material within material receptacle 307. In some examples, there is a separate mass sensor for each ground engaging element (e.g., tire or track) of the mobile machine. Additionally, one or more mass sensors 380 can also be included on a hitch of mobile machine 100 (e.g., hitch of towing vehicle) or a tongue/tow bar of mobile machine 100 (e.g., tongue/tow bar of towed implement) and generate a signal in response to force applied by towed implement on the hitch. In some examples, mass sensors 380 are disposed within material receptacle 307, for instance, one or more mass sensors 380 disposed at different locations within material receptacle 307. As discussed, mobile machine 100 can include more than one mass sensor 380, where each mass sensor 380 is associated with a different location and thus, a mass distribution (as well as a change in the mass distribution) of the mass within material receptacle can be derived. In this way, a change in the mass at one sensor location due to material movement within material receptacle 307 (such as to another mass sensor location) can be distinguished from material spilling from material receptacle 307. Additionally, the mass sensed by mass sensors 380 can be tracked over time to indicate change, rate, loss, gain, etc.

Audible/acoustic sensors 382 detect noise (e.g., sound waves) generated by material contacting surfaces outside of the interior of material receptacle 307, such as a cab roof of mobile machine 100, an exterior side (e.g., top side or outer side, or both) of material receptacle 307, a frame of mobile machine 100, surface of worksite, as well as various other surfaces, and generate sensor signals based on the noise generated by the material contacting surfaces outside of the interior of material receptacle 307. In some examples, audible/acoustic sensors 382 include one or more microphones. In some examples, audible/acoustic sensors 382 may include and/or may be positioned proximate to a strike plate which is positioned on portions of mobile machine 100 in areas where material may contact the strike plate when the material has spilled out of the material receptacle 307. Contact between the strike plate, or other surfaces outside of material receptacle 307, produces a sound which is detected by audible/acoustic sensors 382.

Electromagnetic radiation (ER) sensors 382 detect electromagnetic radiation that travels through an area outside of the interior of material receptacle 307. Material having spilled out of material receptacle 307 and in the area outside of material receptacle 307 interacts with the electromagnetic radiation, such as by attenuating the electromagnetic radiation received by ER sensors 382, blocking at least a portion of the electromagnetic radiation from being received by ER sensors 382, or by causing reflection of electromagnetic radiation back towards ER sensors 382. In some examples, ER sensors 382 can include an ER transmitter that transmits electromagnetic radiation and a receiver that receives the transmitted electromagnetic radiation. Material, present in the area through which the electromagnetic radiation is transmitted, disrupts (e.g., blocks, attenuates, etc.) the reception of and/or the strength of the received electromagnetic radiation at the receiver. The disruption can be detected to indicate the presence of material in the area. In other examples, material present in the area through which the electromagnetic radiation is transmitted is reflected form the material and back towards the receiver. The received reflected electromagnetic radiation can indicate the presence of material in the area. In other examples, the ER sensors only include an electromagnetic radiation receiver that receives electromagnetic radiation. Material presence in an area in which the receiver is disposed to view (i.e., receive electromagnetic radiation through) disrupts the reception of the electromagnetic radiation. This disruption can be detected to indicate the presence of material in the area.

Imaging systems 386 are configured to image areas outside of material receptacle 307. Imaging systems 386 can include on or more imaging devices, such as one or more cameras. Material in the images in areas outside of the material receptacle 307 can indicate spillage of the material from material receptacle 307. In one example, the field of view of imaging systems 386 can include areas inside and outside of material receptacle 307. The areas outside of material receptacle 307 can be identified and zoned by subsequent image processing of images generated by imaging systems 386 such that material in the image in the identified zones can be identified to detect material in areas outside of material receptacle 307.

Contact sensors 388 are disposed in areas outside of material receptacle 307 such as a cab roof of mobile machine 100, an exterior or top side of material receptacle 307, a frame of mobile machine 100, as well as various other locations, and detect contact between material and contact sensors 388. Contact sensors 388 can include a contact pad, such as a piezo electric contact pad, which generates an electrical signal in response to the force of contact between the pad and the material. In other examples, contact sensors 388 can include a displaceable object which is displaced by the force of contact between material and the displaceable object. The displacement can be detected by a sensor such as a potentiometer or a Hall effect sensor and can be used to detect the presence of material outside of material receptacle 307.

Material spill sensors 180 can include other material spill sensors 389 as well.

Other sensors 352 can include a variety of other sensors, including, but not limited to, the various other sensors described herein, such as described above with regard to FIGS. 1-2B.

As will be discussed in greater detail below, the outputs of material spill sensors 180 can be used not only for the detection of material outside of material receptacle 307, that is, to detect material spill, but also to detect a location of the material spill, and/or an amount of material spilled from material receptacle 307.

Controllable subsystems 302 illustratively include material transfer subsystem 314, steering subsystem 316, propulsion subsystem 318, and can include other subsystems 320 as well. The controllable subsystems 302 are now briefly described. Material transfer subsystem 314, itself, includes spout 322, chute 324, auger 325, and can include other items 326 such as one or more controllable actuators.

Material transfer subsystem 314 can be controlled to control the transfer of material from material receptacle 307 to another location, such as another material receptacle on another machine, a material storage area such as a grain bin, another material transfer system, such as an elevator, as well as various other locations. Material transfer subsystem includes an auger 325 which can be operated to convey material in material receptacle 307 through chute 324 and spout 322. The operation of auger 325 can be actuated by one or more actuators. The position of chute 324 and spout 322 can be controlled, such as by actuation of one or more actuators, to position subsystem 314 to transfer material to a desired location. Thus, material transfer subsystem 314 can include, as one or more other items 326, one or more actuators. Material transfer subsystem 314 can be controlled by control system 304 to initiate or end a material transfer operation.

Steering subsystem 316 controls the heading of mobile machine 100, by steering the ground engaging elements (e.g., wheels or tracks 144, 207, 209, 257, 259, etc.). Steering subsystem 316 can adjust the heading of mobile machine 100 based on action signals generated by control system 304. For example, based on sensor signals generated by material spill sensors 180 indicative of material spillage from material receptacle 307, material spill control system 304 can generate action signals to control steering subsystem 316 to adjust the heading of mobile machine 100. In another example, material spill control system 304 can generate action signals to control steering subsystem 316 to adjust the heading of mobile machine 100 to comply with a commanded route, such as an operator or user commanded route, or, and as will be described in more detail below, a route generated by control system 304, as well as various other commanded routes.

Propulsion subsystem 318 is configured to propel mobile machine 100 over the worksite surface, such as by driving movement of ground engaging elements (e.g., wheels or tracks 144, 207, 209, 257, 259, etc.). It can include a power source, such as an internal combustion engine or other power source, a set of ground engaging elements (e.g., wheels or tracks), as well as other power train components. In one example, propulsion subsystem 318 can adjust the speed of mobile machine 100 based on action signals generated by material spill control system 304, which can be based detection of material spill out of material receptacle 307 as detected by material spill sensors 180. For example, based on detected material spill, propulsion subsystem 318 can be controlled to adjust a travel speed of mobile machine 100, such as to prevent or reduce the likelihood of further material spill. In other examples, based on detected material spill, propulsion subsystem 318 can be controlled to bring mobile machine 100 to a stop.

Other controllable subsystems 320 can include various other controllable subsystems, for example, but not by limitation, a map generator, such as material spill map generators 402 (shown below) and an interface, such as operator interfaces 360 or user interfaces 364, or both.

Material spill control system 304 is configured to receive or otherwise obtain various data, such as sensor data, user or operator inputs, data from data stores, and various other types of data. Based on the data, control system 304 can make various determinations and generate various action signals. For example, based on sensor data provided by material spill sensors 180, material spill control system 304 can determine material spill characteristics such as the occurrence of material spill, that is, the spillage of material from material receptacle 307 and an amount of material spilled from material spill receptacle 307. Material spill control system 304 can also determine a geographic location of the detected material spills based on detected occurrence of material spill as indicated by sensor data provided by material spill sensors 180 and location data provided by geographic positions sensors 346. Further material spill control system 304 can determine a location of the material spills relative to the mobile machine 100, or a component of the mobile machine 100, such as material receptacle 307, based on detected occurrence of material spill as indicated by sensor data provided by material spill sensors 180 and a location of the material spill sensors on the mobile machine 100 or a location that the material spill sensors 180 are observing relative to the mobile machine. For instance, control system 304 can determine that the material spill occurred on the left, right, front, or back sides of the mobile machine 100 or material receptacle 307 and further a more precise location along each side. Material spill control system 304 can also generate action signals to generate indications, such as displays, alerts, recommendations, etc. such as on operator interfaces 360, user interfaces 364, at other mobile machines 370, at remote computing system 368, etc.

As shown in FIG. 3 material spill control system 304 can include or otherwise access one or more processors/controllers/servers 312. As will be shown in FIG. 4, material spill control system 304 can include various other items.

FIG. 4 is a block diagram illustrating one example of material spill control system 304 in more detail. Material spill control system 304 can include one or more processors, controllers, or servers 312, material spill analyzer 400, material spill map generator 402, data capture logic 404, action signal generator 406, machine learning component 410, and can include other items 412 as well. Material spill analyzer 400, itself, can include material spill detector 414, material spill location detector 416, material spill amount detector 418, mass signal processing component 420, audible/acoustic signal processing component 422, electromagnetic radiation (ER) signal processing component 424, image processing component 426, contact signal processing component 428, and it can include other items 430 as well. Data capture logic 404, itself, can include sensor accessing logic 434, data store accessing logic 436, and it can include other items 438 as well.

In operation, material spill control system 304 determines characteristics of material spill based on obtained data, such as sensor data from one or more sensors 310. For example, material spill control system 304 can determine material spill characteristics, such as the occurrence of material spill, the location of material spill (e.g., geographic location on the field or relative to the mobile machine 100, or both), and the amount of material spilled. Material spill control system 304 can generate a variety of material spill outputs, such as various representations of the characteristics of material spill, such as displays, alerts, and various other indications, as well as a material spill map that indicates the locations of material spill occurrence as well as other characteristics (e.g., amount) of material spill at the worksite. Material spill control system 304 can generate action signals to control the operation of various components of agricultural system architecture 300 (e.g., mobile machine 100, operator interfaces 360, user interfaces 364, other mobile machines 370, remote computing systems 368, etc.), as well as to control the operation of various components or items of the components of agricultural system architecture 300, such as controllable subsystems 302 of mobile machine 100. Further, material spill control system 304 can generate action signals to provide indications such as displays, recommendations, alerts, notifications, as well as various other indications on an interface or interface mechanism, such as on operator interfaces 360 or user interfaces 364. The indications can include audio, visual or haptic outputs.

Data capture logic 404 captures or obtains data that can be used by other items in material spill control system 304. Data capture logic 404 can include sensor accessing logic 434, data store accessing logic 436, and other logic 438. Sensor accessing logic 434 can be used by material spill control system 304 to obtain or otherwise access sensor data (or values indicative of the sensed variables/characteristics) provided from sensors 310 that can be used to determine characteristics of material spill, such as the occurrence, location, and amount of material spill at the worksite. For illustration, but not by limitation, sensor accessing logic 434 can obtain sensor signals from material spill sensors 180 indicative of characteristics of material spill.

Additionally, data store accessing logic 436 can be used to obtain or otherwise access data previously stored on data stores 308, or data stored at remote computing systems 368. For illustration, but not by limitation, data store accessing logic 436 can obtain data indicative of threshold values of signals generated by material spill sensors 180 for comparison to determine characteristics of material spills, stored sensor data generated by sensors 310, positional information of components of mobile machine 100, such as positions of material spill sensors 180 on mobile machine 100, as well as various other stored data.

Upon obtaining various data, material spill analyzer 400 analyzes the data to determine characteristics of material spills at the worksite. As shown in FIG. 4, material spill analyzer 400 includes material spill detector 414, material spill location detector 416, material spill amount detector 418, mass signal processing component 420, audible/acoustic signal processing component 422, electromagnetic radiation (ER) signal processing component 424, image processing component 426, contact signal processing component 428, and it can include other items 430 as well.

Material spill detector 414 determines the occurrence of material spill based on outputs from the various processing components 420 - 428. Material spill amount detector 418 determines an amount of material spilled based on outputs from the various processing components 420-428. Material spill location detector 416 determines a geographic location of material spills at the worksite based on determinations of material spill by material spill detector 414 and location data indicative of a location of mobile machine 100 at the time the characteristics indicative of material spill were detected, such as location data provided by geographic positions sensors 346. It will be understood that the sensor data obtained by material spill analyzer 400 can be timestamped such that a location of the mobile machine corresponding to the sensor signals can be identified (i.e., a location signal having a corresponding timestamp). Additionally, material spill location detector 416 can determine a location of the material spills relative to the mobile machine 100, or a component of the mobile machine 100, such as material receptacle 307, based on determination of material spill by material spill detector 414 and arrangement characteristics of the material spill sensor(s) 180 that detected the material spill, such as the location(s) of the material spill sensor(s) 180 that detected the material spill, a location of an area sensed by the material spill sensor(s) that detected the material spill, or the point of view of the material spill sensor(s) 180. In some examples, such as when material spill sensors 180 generate an image, a distance of the material that has been spilled from the material sensor that captured the image can be derived and used by material spill location detector 416 to determine a location of the material spill along a length of a side of mobile machine 100. As an illustrative example, where the material spill sensor data was derived from a contact sensor 380 disposed on a cab roof of mobile machine 100, material spill location detector 416 determines that the material spill occurred on the cab roof and/or in front of the material receptacle 307. In another example, the particular material sensor 180 may be disposed to observe or detect areas (or characteristics in areas) around the material receptacle and thus detection of material spill in those areas can be used by material spill location detector 316 to determine a location of the material spill relative to the mobile machine and/or the material receptacle 307.

Mass signal processing component 420 obtains mass sensor data generated by mass sensors 380 and processes the mass sensor data to identify a mass signal value indicative of a mass (i.e., weight) of material in material receptacle 307. In some examples, mass sensors 380 generate an electrical signal indicative of the mass of material in material receptacle 307. Mass signal processing component 420 identifies a value of the electrical signal to determine a mass of the material in material receptacle 307. Mass signal processing component 420 also identifies a change of the mass signal value over time to determine a change in the mass of the material in material receptacle 407. The identified change in the mass of the material in material receptacle 407 can be used by material spill detector 414 to determine the occurrence of material spill 414 or by material spill amount detector 418 to determine an amount of material spilled. For example, a decrease in the mass signal value can indicate material spillage from material receptacle 307, and the amount of decrease can indicate the amount of material spilled from material receptacle 307. In some examples, the change in the mass signal value can be compared to an expected change in the mass signal value to determine the occurrence of material spill and/or the amount of material spill. For instance, where mobile machine 100 is receiving material in material receptacle 307, such as from a material transfer subsystem of another machine, the mass signal value may not be increasing or may not be increasing at the expected rate. For instance, knowing the material transfer rate of the transferring vehicle (e.g., 10 bushels per second) and the weight of the material being transferred (e.g., 56 pounds per bushel of corn), an expected mass signal value change (560 pounds per second) can be determined. Where there is no change in the mass signal value or where the mass signal value does not change at the expected rate, material spill detector 414 can determine the occurrence of material spill and material spill amount detector 418 can determine an amount of material spill. It will be understood that a mass signal value indicative of an empty weight of the mobile machine 100 can be stored in data stores 308 and accessed by mass signal processing component 420 such that the generated mass signal value can be compared to the empty weight mass signal value. In some examples, at the beginning of an operation, when the mobile machine is empty (or at least material from the operation has not yet been stored in the material receptacle 307), a mass signal value can be generated and used as a reference.

Additionally, where there are multiple mass sensors 380 disposed at different locations on mobile machine 100, the mass sensor data of the multiple mass sensors 380 can be aggregated by mass signal processing component 420 to identify as a mass signal value, an aggregated mass signal value. Additionally, where a change in the mass indicated by the sensor data provided by one mass sensor 380 indicates a change in mass of the material, mass signal processing component 420 can aggregate the change, if any, indicated by the mass sensor data provided by other mass sensors 380 to differentiate between mass signal value change due to material spill and mass signal value change due to material shift within material receptacle 307.

Audible/acoustic signal processing component 422 obtains audible/acoustic sensor data generated by audible/acoustic sensors 382 and processes the audible/acoustic sensor data to identify an audible/acoustic signal value indicative of a noise generated by contact between material from material receptacle 307 and objects outside of material receptacle 307. In some examples, audible/acoustic sensors 382 generate an electrical signal in response to noise generated by contact between material from material receptacle 307 and object(s) outside of material receptacle 307. Audible/acoustic signal processing component 422 identifies a value of the electrical signal. The identified audible/acoustic signal value can be used by material spill detector 414 to determine the occurrence of material spill as well as by material spill amount detector 418 to determine an amount of material spilled. For instance, the audible/acoustic signal value may vary from a value at which no material spillage occurs and a value at which at least some material spillage occurs (e.g., a threshold value). An audible/acoustic signal value at or exceeding the threshold value can indicate the occurrence of material spill. The amount to which the audible/acoustic signal value exceeds the threshold value can indicate an amount of material spilled (e.g., a higher audible/acoustic signal value may indicate that more material spilled as compared to a lower audible acoustic signal value). Additionally, audible/acoustic signal processing 422 can identify an audible/acoustic signal width value which indicates an amount of time that the audible/acoustic signal value was at or exceeded the threshold value. The audible/acoustic signal width value can be used by material spill amount detector 418 to determine an amount of material spilled (e.g., the longer the audible/acoustic signal value is at or exceeds the threshold value, the more material that is spilled). Audible/acoustic signal processing component 422 can also generate an aggregated audible/acoustic signal value indicative of an aggregate audible/acoustic signal value over a given period of time, such as during a period of time in which the audible/acoustic signal value was at or exceeded the threshold value. The aggregated audible/acoustic signal value can be used by material spill amount detector 418 to determine an amount of material spilled.

Electromagnetic radiation (ER) signal processing component 424 obtains electromagnetic radiation (ER) sensor data from electromagnetic (ER) sensors 384 and processes the ER sensor data to identify an ER signal value indicative of a characteristic of the electromagnetic radiation received by ER sensors 384. In some examples, ER sensors 384 generate an electrical signal in response to received electromagnetic radiation. ER signal processing component 424 identifies a value of the electrical signal. The identified ER signal value can be used by material spill detector 414 to determine the occurrence of material spill as well as by material spill amount detector 418 to determine an amount of material spilled. For instance, the ER signal value may vary from a value at which no material spillage occurs and a value at which at least some material spillage occurs (e.g., a threshold value). An ER signal value at or exceeding the threshold value can indicate the occurrence of material spill. The amount to which the ER signal value exceeds the threshold value can indicate an amount of material spilled (e.g., the amount to which the electromagnetic radiation was disturbed by the presence of material may indicate more material being present). Additionally, ER signal processing component 424 can identify an ER signal width value which indicates an amount of time that the ER signal value was at or exceeded the threshold value. The ER signal width value can be used by material spill amount detector 418 to determine an amount of material spilled (e.g., the longer the ER signal value is at or exceeds the threshold value, the more material that is spilled). ER signal processing component 424 can also generate an aggregated ER signal value indicative of an aggregate ER signal value over a given period of time, such as during a period of time in which the ER signal value was at or exceeded the threshold value. The aggregated ER signal value can be used by material spill amount detector 418 to determine an amount of material spilled.

Image processing component 426 obtains images generated by imaging systems 386 and processes the images to identify one or more of presence of material spilled out of material receptacle 307 in an area outside of material receptacle 307, an amount of time in which material was present in an area outside of material receptacle 307, and an amount of material present within the area outside of material receptacle. In some examples, the images obtained by image processing component 426 may include areas outside of material receptacle 307 and areas inside of material receptacle 307. In such an example, image processing component 426 can identify zones of the image which are outside of material receptacle 307 such that material present within those zones are indicative of material spillage. In other examples, the images obtained by image processing component 426 may only include areas outside of material receptacle such that presence of material anywhere in the image indicates material spillage.

Image processing component 426 processes the images to identify material, such as grain, in the image in areas outside of material receptacle 307. Based on the identification of material in the image in areas outside of material receptacle 307, material spill detector 414 can determine the occurrence of material spill. Further, image processing 426 can identify an amount of material present in areas outside of material receptacle 307, such as by summation of identified individual materials, such as individual grains, or by calculation of a volume based on an area of the image taken up by identified material. These are merely some examples. Based on the identified amount of material in the image in areas outside of material receptacle 307, material spill amount detector 418 can determine the amount of material spilled. Additionally, image processing component 426 can identify an amount of time during which material was present in areas outside of material receptacle 307 as well as an amount of material present in areas outside of material receptacle 307 over that period of time, on the basis of which material spill detector 418 can determine the amount of material spilled.

It will be understood that image processing component 426 can utilize a variety of image processing techniques or methods, such as sequential image comparison, RGB, edge detection, black/white analysis, machine learning, neural networks, pixel testing, pixel clustering, shape detection, as well any number of other suitable image processing and data extraction techniques and/or methods.

Contact signal processing component 428 obtains contact sensor data from contact sensors 388 and processes the contact sensor data to identify a contact signal value indicative of contact between material from material receptacle 307 and contact sensors 388. In some examples, contact sensors 388 generate an electrical signal in response to contact between material from material receptacle 307 and contact sensors 388. Contact signal processing component 428 identifies a value of the electrical signal. The identified contact signal value can be used by material spill detector 414 to determine the occurrence of material spill as well as by material spill amount detector 418 to determine an amount of material spilled. For instance, the contact signal value may vary from a value at which no material spillage occurs and a value at which at least some material spillage occurs (e.g., a threshold value). A contact signal value at or exceeding the threshold value can indicate the occurrence of material spill. The amount to which the contact signal value exceeds the threshold value can indicate an amount of material spilled (e.g., a higher contact signal value may indicate that more material spilled as compared to a lower contact signal value). Additionally, contact signal processing 428 can identify a contact signal value width value which indicates an amount of time that the contact signal value was at or exceeded the threshold value. The contact signal width value can be used by material spill amount detector 418 to determine an amount of material spilled (e.g., the longer the contact signal value is at or exceeds the threshold value, the more material that is spilled). Contact signal processing 428 can also generate an aggregated contact signal value indicative of an aggregate contact signal value over a given period of time, such as during a period of time in which the contact signal value was at or exceeded the threshold value. The aggregated contact signal value can be used by material spill amount detector 418 to determine an amount of material spilled.

It will be understood that processing components 420 - 428 can utilize sensor signal filtering, such as noise filtering, sensor signal categorization, aggregation, as well as a variety of other processing techniques.

Based upon the material spill characteristics determined by material spill analyzer 400, material spill control system 304 can use action signal generator 406 to generate a variety of action signals to control the operation of the components of agricultural system architecture 300 or to provide indications, such as displays, alerts, recommendations, or other indications on an interface or interface mechanisms. The indications can include audio, visual, or haptic outputs. For instance, based on the determined material spill characteristics, material spill control system 304 can generate action signal(s) to control propulsion subsystem 318 to control the travel speed of mobile machine 100, to control steering subsystem 316 to control the heading or route of mobile machine, and/or to control material transfer subsystem 314 such as to initiate a material transfer operation to transfer material from material receptacle 307 to a desired location. In other examples, based on the determined material spill characteristics, a display, recommendation, and/or other indication can be generated and surfaced to an operator 362 on an operator interface 360 or to a remote user 366 on a user interface 364, or both. Based on the generated displays, operators 362 or remote users 366 can manually (e.g., via an input on an interface) adjust the settings or operation of a component of agricultural system architecture 300. These are merely examples, and material spill control system 304 can generate any number of action signals used to control any number of machine settings or operations of any number of machines or to generate any number of displays, recommendations, or other indications.

Other items 430 can include various other processing configured to process a variety of other data (e.g., accessed from data store(s), received from sensor(s), operator/user inputs, as well as various other sources of data) and identify values indicative of characteristics of material spills, such as an occurrence of material spill, an amount of material spilled, as well as the locations of material spills.

Material spill map generator 402 generates a variety of maps based on the material spill characteristics determined by material spill analyzer 400. For example, map generator 402 can generate a map of a worksite at which mobile machine 100 operates and includes indications of material spill locations as well as values, such as an amount of material spilled, associated with the material spill locations. The map(s) generated by material spill map generator 402 can be output for display on various interface mechanisms, such as operator interface mechanisms 360, user interface mechanisms 364, as well as interfaces associated with other vehicles 370. The map(s) can also be used in future operations, such as in subsequent cleanup efforts, for identification and/or treatment of volunteer crops, as well as for control of future operations, such as to adjust operations of the machines in those locations to avoid spillage.

As illustrated in FIG. 4, material spill control system 304 can include action signal generator 406. Action signal generator 406 can generate a variety of action signals, used to control an action of components of computing architecture 300. For instance, action signal(s) can be used to control an operation of mobile machine 100 such as controlling a speed of mobile machine 100, controlling a heading of mobile machine 100, controlling the operation of material transfer subsystem 314, as well as controlling and/or adjusting a variety of other operations or machine settings. In another example, action signal(s) are used to provide displays, recommendations, and/or other indications (e.g., alerts) on an interface or interface mechanism, such as to an operator 362 on an operator interface mechanism 360 or to a remote user 366 on a user interface mechanism 364. The indications can include audio, visual, or haptic outputs. The indication(s) can be indicative of the material spill characteristics, such as the occurrence of material spill(s), amount(s) of material spilled, and/or the locations of material spill(s), a material spill map generated by map generator 402, as well as a variety of other indications. In one example, the indication can be in the form of an overhead and/or surround display view that includes a depiction of mobile machine 100 with zones around the mobile machine indicating where material spills have occurred relative to mobile machine 100.

Additionally, action signal generator 406 can generate action signals to control the operation of other vehicles 370 to, for instance, travel to locations on the worksite to receive material from mobile machine 100. Similarly, action signals can be generated to recommend to the operator or user to adjust the speed of mobile machine 100, to adjust the heading of mobile machine 100, and/or to initiate a material transfer operation. These are merely examples. Material spill control system 304 can generate any number of a variety of action signal(s) used to control any number of actions of any number of components of agricultural system architecture 300.

FIG. 4 also shows that material spill control system 304 can include machine learning component 410. Machine learning component 410 can include a machine learning model that can include machine learning algorithm(s), such as, but not limited to, memory networks, Bayes systems, decision tress, Eigenvectors, Eigenvalues and Machine Learning, Evolutionary and Genetic Algorithms, Expert Systems/Rules, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Random Forests, Reinforcement Learning or Reward-based machine learning, and the like.

Machine learning component 410 can improve the determination of material spill characteristics by improving the algorithmic process for the determination, such as by improving the recognition of values and/or characteristics indicated by sensor data which indicate characteristics of material spill. Machine learning component 410 can also utilize a closed-loop style learning algorithm such as one or more forms of supervised machine learning.

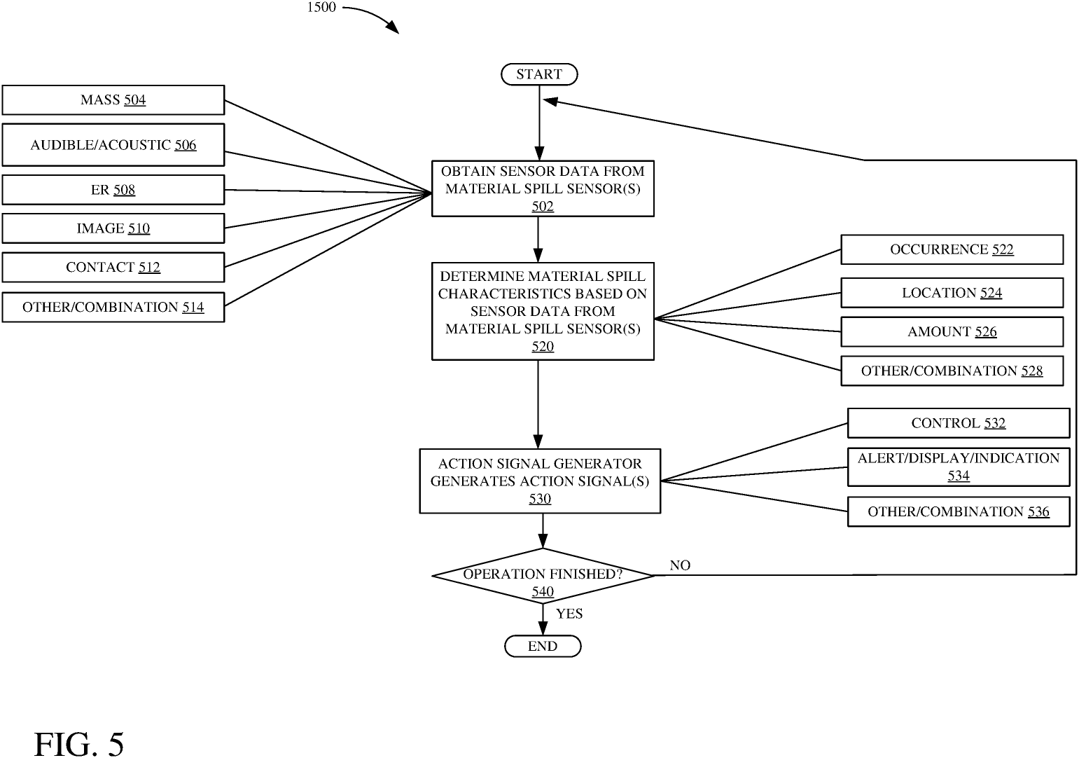

FIG. 5 is a flow diagram showing an example operation of the material spill control system 304 shown in previous figures in determining material spill characteristics. It is to be understood that the operation can be carried out at any time or at any point through an agricultural operation. Further, while the operation will be described in accordance with mobile machine 100, it is to be understood that other machine with a material control system 304 can be used as well.

Processing begins at block 502 where data capture logic 404 obtains sensor data generated by one or more material spill sensors 180. As indicated by block 504, the sensor data can be mass sensor data generated by one or more mass sensors 380. As indicated by block 506, the sensor data can be audible/acoustic sensor data generated by one or more audible/acoustic sensors 382. As indicated by block 508, the sensor data can be electromagnetic radiation (ER) sensor data generated by one or more electromagnetic radiation (ER) sensors 384. As indicated by block 510, the sensor data can be image(s) generated by one or more imaging systems 386. As indicated by block 512, the sensor data can be contact sensor data generated by one or more contact sensors 388. As indicated by block 514, the sensor data can be other types of material spill sensor data generated by one or more other material spill sensors 389 or can be a combination of sensor data generated by a combination of sensors 380, 382, 384, 386, 388, and 389.

Once the material spill sensor data has been obtained at block 502, processing proceeds at block 520 where material spill analyzer 400 determines one or more characteristics of material spill(s) based on the obtained sensor data generated by the one or more material spill sensors 180, as well as based on, in some examples, other data such as geographic location data generated by geographic position sensors 346 or positional information indicative of positions of material sensors 180 which can be, for example, stored in data store 308. Material spill analyzer 400 can determine the occurrence of material spill(s), as indicated by block 522. Material spill analyzer 400 can determine the location of material spill(s), such as the geographic location of the material spill(s) on the field or the location of the material spill(s) relative to the mobile machine 100, as indicated by block 524. In one example, determining the geographic location of material spill(s) on the fields includes obtaining location data indicative of location(s) of the mobile machine, such as location data provided by geographic position sensors 346. In one example, determining the location of the material spill(s) relative to the mobile machine 100 includes obtaining positional information indicative of the position of the material spill sensor(s) 180 on the mobile machine 100 or position information indicative of the position of an area sensed by material spill sensor(s) 180 relative to the mobile machine 100. Material spill analyzer 400 can determine the amount of material spilled, as indicated by block 526. Material spill analyzer 400 can determine various other characteristics of the material spill(s) or a combination of the occurrence, location, and amount, as indicated by block 528.

Processing proceeds at block 530 where action signal generator 406 generates one or more action signals based on the determined material spill characteristic(s). As indicated by block 532, action signal generator 406 can generate action signals to control one or more items of architecture 300, such as mobile machine 100, other vehicles 370, remote computing systems 368, as well as various other items. For instance, control signal generator 406 can control one or more other vehicles 370 to travel to a location at the worksite to receive material from mobile machine 100. At block 532, action signal generator can generate action signals to control components of the various items of architecture 300, such as one or more controllable subsystems 302 of mobile machine 100. For example, at block 532, action signal generator 406 can generate action signals to control material transfer subsystem 314 such as to initiate a material transfer operation, to control steering subsystem 316 to control a heading of mobile machine 100, and to control propulsion subsystem 318 to control a travel speed of mobile machine 100. At block 534, action signal generator can generate action signals to control an interface mechanism, such as one or more operator interfaces 360 and/or user interfaces 364, to provide an alert, display, recommendation, or other indication based on the material spill characteristic(s). In one example, the indication includes a material spill map generated by material spill map generator 402. At block 536, action signal generator 406 can generate various other action signals or a combination of the action signals described at blocks 532 and 534.

Processing proceeds at block 540 where it is determined whether the operation of mobile machine 100 is finished. If, at block 540, it is determined that the operation has not been finished, processing proceeds at block 502 where additional sensor data provided by one or more material sensors 180 is obtained. If, at block 540, it is determined that the operation has been finished, then processing ends.

The present discussion has mentioned processors, controllers, and servers. In one example, the processors, controllers, and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

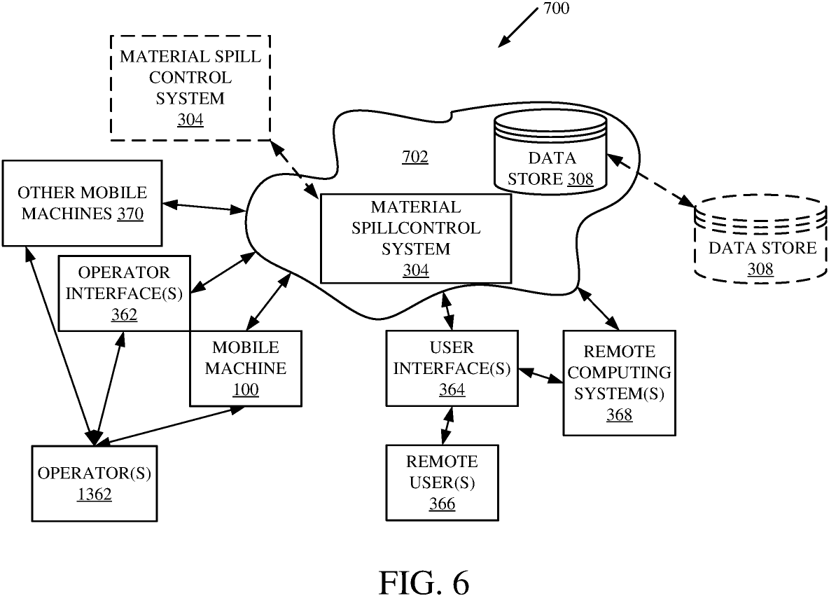

FIG. 6 is a block diagram of mobile machine 100, shown in FIG. 2, except that it communicates with elements in a remote server architecture 700. In one example, remote server architecture 700 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous figures as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 6, some items are similar to those shown in previous figures and they are similarly numbered. FIG. 6 specifically shows that material spill control system 304 and data store 308 can be located at a remote server location 702. Therefore, mobile machine 100, other vehicles 370, remote computing system 368, operators 362, or remote users 366 accesses those systems through remote server location 702.

FIG. 6 also depicts another example of a remote server architecture. FIG. 5 shows that it is also contemplated that some elements of previous FIGS are disposed at remote server location 702 while others are not. By way of example, material control system 304 or data store 308 can be disposed at a location separate from location 702, and accessed through the remote server at location 702. Regardless of where they are located, they can be accessed directly by mobile machine 100, other mobile machines 370, remote computing system 368, operators 362, or remote users 366 through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the mobile machine comes close to the fuel truck for fueling, the system automatically collects the information from the mobile machine using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the harvester until the mobile machine enters a covered location. The mobile machine, itself, can then send the information to the main network.

It will also be noted that the elements of previous figures, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

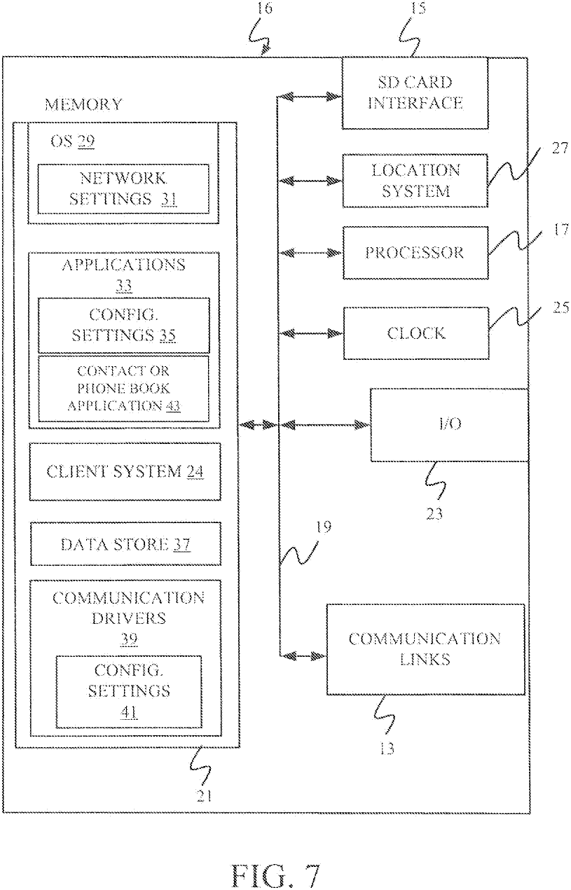

FIG. 7 is a simplified block diagram of one illustrative example of a handheld or mobile computing device that can be used as a user’s or client’s handheld device 16, in which the present system (or parts of it) can be deployed. For instance, a mobile device can be deployed in the operator compartment of mobile machine 100 for use in generating, processing, or displaying the stool width and position data. FIGS. 7-9 are examples of handheld or mobile devices.

FIG. 7 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

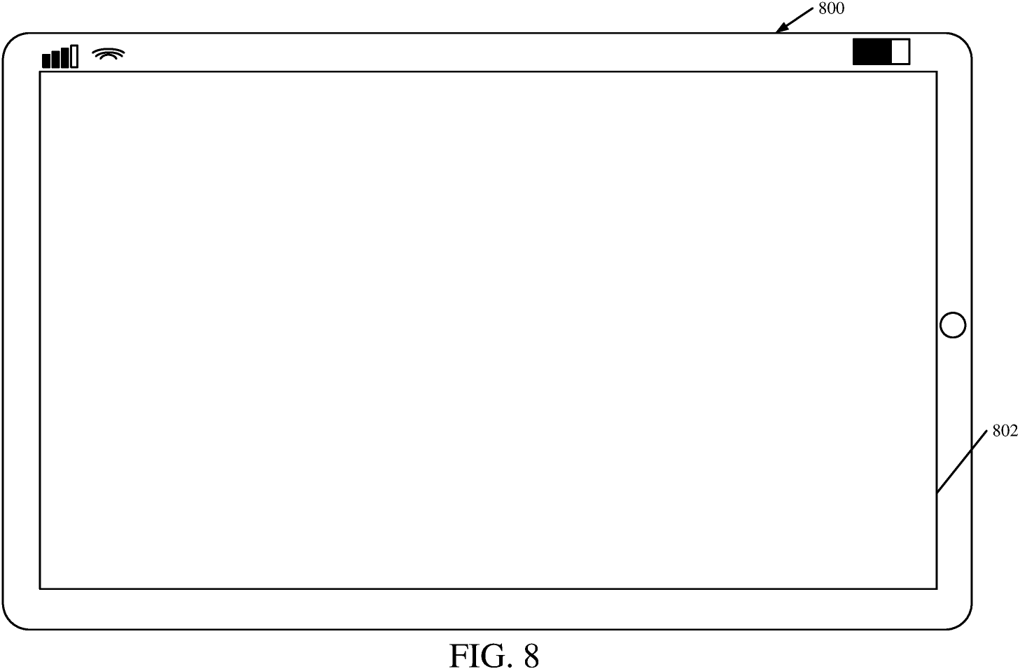

FIG. 8 shows one example in which device 16 is a tablet computer 800. In FIG. 8, computer 800 is shown with user interface display screen 802. Screen 802 can be a touch screen or a pen-enabled interface that receives inputs from a pen or stylus. Computer 800 can also use an on-screen virtual keyboard. Of course, computer 800 might also be attached to a keyboard or other user input device through a suitable attachment mechanism, such as a wireless link or USB port, for instance. Computer 800 can also illustratively receive voice inputs as well.

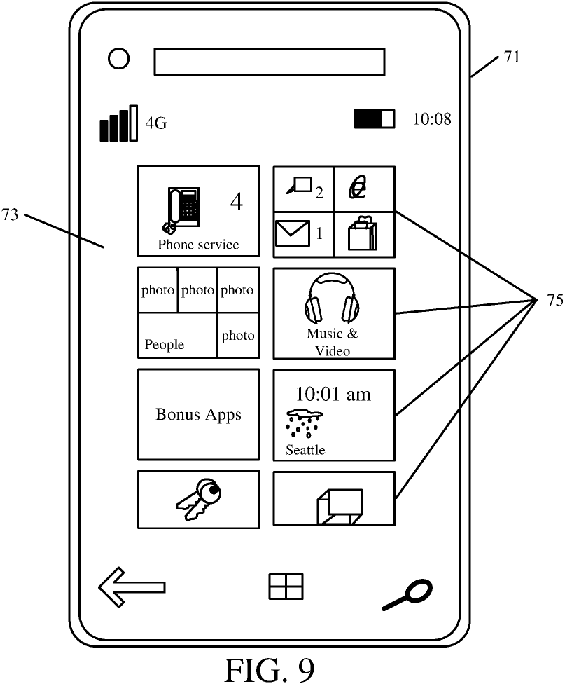

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

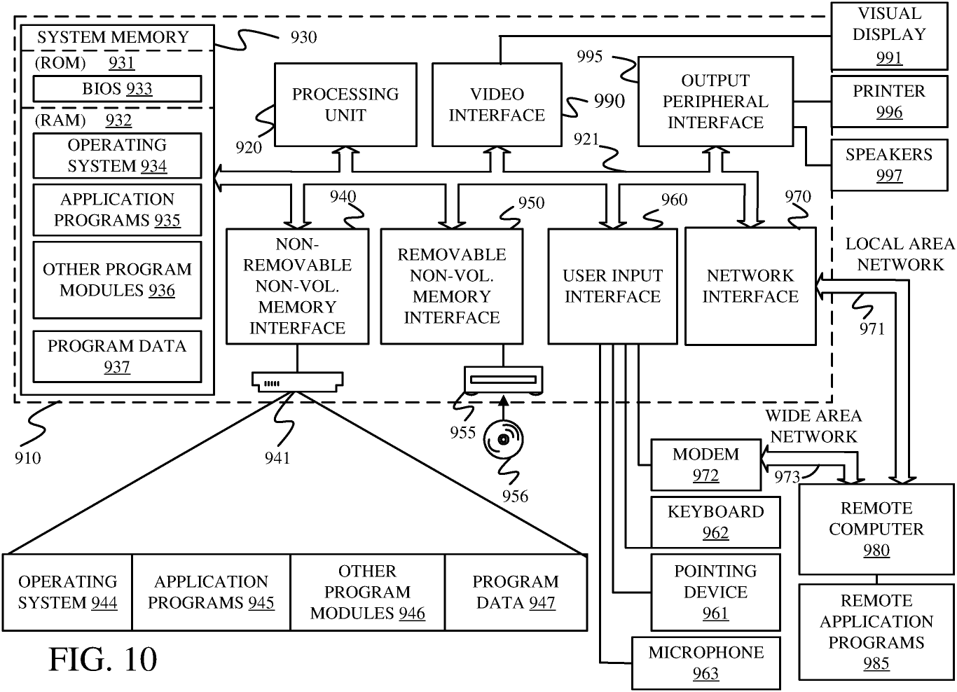

FIG. 10 is one example of a computing environment in which elements of previous figures, or parts of it, (for example) can be deployed. With reference to FIG. 10, an example system for implementing some embodiments includes a general-purpose computing device in the form of a computer 910 programmed to operate as described above. Components of computer 910 may include, but are not limited to, a processing unit 920 (which can comprise processors or servers from previous figures), a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. Memory and programs described with respect to previous figures can be deployed in corresponding portions of FIG. 10.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 10 illustrates operating system 934, application programs 935, other program modules 936, and program data 937.

The computer 910 may also include other removable/non-removable volatile/nonvolatile computer storage media. By way of example only, FIG. 10 illustrates a hard disk drive 941 that reads from or writes to non-removable, nonvolatile magnetic media, an optical disk drive 955, and nonvolatile optical disk 956. The hard disk drive 941 is typically connected to the system bus 921 through a non-removable memory interface such as interface 940, and optical disk drive 955 are typically connected to the system bus 921 by a removable memory interface, such as interface 950.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 910. In FIG. 10, for example, hard disk drive 941 is illustrated as storing operating system 944, application programs 945, other program modules 946, and program data 947. Note that these components can either be the same as or different from operating system 934, application programs 935, other program modules 936, and program data 937.

A user may enter commands and information into the computer 910 through input devices such as a keyboard 962, a microphone 963, and a pointing device 961, such as a mouse, trackball or touch pad. Other input devices (not shown) may include a joystick, game pad, satellite dish, scanner, or the like. These and other input devices are often connected to the processing unit 920 through a user input interface 960 that is coupled to the system bus, but may be connected by other interface and bus structures. A visual display 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 is operated in a networked environment using logical connections (such as a controller area network - CAN, local area network - LAN, or wide area network WAN) to one or more remote computers, such as a remote computer 980.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. In a networked environment, program modules may be stored in a remote memory storage device. FIG. 10 illustrates, for example, that remote application programs 985 can reside on remote computer 980.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile machine comprising:
a frame;
ground engaging elements configured to support the frame above a surface of a worksite;
a material receptacle configured to hold a material;
a material spill sensor configured to detect a characteristic indicative of a material spill characteristic and to generate a sensor signal based on the detected characteristic; and
a control system configured to determine the material spill characteristic based on the sensor signal.

2. The mobile machine of claim 1, wherein the control system is configured to generate action signals to control an action of the mobile machine based on the determined material spill characteristic.

3. The mobile machine of claim 2, wherein the control system generates the action signals to control one or more of:
a material transfer subsystem to initiate a material transfer operation;
a steering subsystem to adjust a heading of the mobile machine;
a propulsion subsystem to adjust a speed of the mobile machine; and
an interface mechanism to surface an indication of the material spill characteristic.

4. The mobile machine of claim 1, wherein the material spill sensor comprises an imaging system configured to capture an image of an area outside of the material receptacle, the mobile machine further comprising:
an image processor configured to identify material in the area outside of the material receptacle based on the image.

5. The mobile machine of claim 1, wherein the material spill sensor comprises an electromagnetic radiation (ER) sensor configured to receive electromagnetic radiation that travels through an area outside of the material receptacle and to generate the sensor signal based on electromagnetic radiation received by the ER sensor.

6. The mobile machine of claim 1, wherein the material spill sensor comprises an audible/acoustic sensor configured to detect a noise caused by contact between the material and a surface outside of the material receptacle and to generate the sensor signal based on the detected noise.

7. The mobile machine of claim 1, wherein the material spill sensor comprises a contact sensor disposed, at least partially, in a location outside of the material receptacle and configured to detect contact with the material and to generate the sensor signal based on the detected contact.

8. The mobile machine of claim 1, wherein the material spill sensor comprises a mass sensor configured to detect a mass of the material in the material receptacle and generate the sensor signal based on the detected mass.

9. The mobile machine of claim 1, wherein the control system is configured to determine, as the material spill characteristic, one or more of an occurrence of material spill and an amount of material spilled based on the sensor signal.

10. The mobile machine of claim 1, wherein the control system is configured to determine one or more of a location of the material spillage at the worksite based on the sensor signal and location data indicative of a location of the mobile machine at the time the characteristic was detected and a location of the material spillage relative to the mobile machine based on the sensor signal and arrangement characteristics of the material spill sensor.

11. A computer-implemented method comprising:
detecting, with a material spill sensor, a characteristic indicative of a material spill characteristic;
generating a sensor signal based on the detected characteristic;
determining the material spill characteristic based on the sensor signal; and
generating an action signal based on the determination of the material spill characteristic.

12. The computer-implemented method of claim 11, wherein detecting, with the material spill sensor, the characteristic indicative of the material spill characteristic comprises:
obtaining an image with an imaging system on a mobile machine of an area outside of a material receptacle of the mobile machine.

13. The computer-implemented method of claim 11, wherein detecting, with the material spill sensor, the characteristic indicative of the material spill characteristic comprises:
receiving, with an electromagnetic radiation (ER) sensor, electromagnetic radiation that travels through an area outside of a material receptacle of a mobile machine.

14. The computer-implemented method of claim 11, wherein detecting, with the material spill sensor, the characteristic indicative of the material spill characteristic comprises:
detecting, with an audible/acoustic sensor, a noise caused by contact between the material and a surface outside of a material receptacle of a mobile machine.

15. The computer-implemented method of claim 11, wherein detecting, with the material spill sensor, the characteristic indicative of the material spill characteristic comprises:
detecting, with a contact sensor disposed outside of a material receptacle of a mobile machine, contact with the material.

16. The computer-implemented method of claim 11, wherein detecting, with the material spill sensor, the characteristic indicative of the material spill characteristic comprises:
detecting, with a mass sensor, a mass of material within a material receptacle of a mobile machine.

17. The computer-implemented method of claim 11, wherein determining the material spill characteristic based on the sensor signal comprises:
determining one or more of occurrence of material spill and an amount of material spilled out of a material receptacle of a mobile machine based on the sensor signal.

18. The computer-implemented method of claim 11, wherein determining the material spill characteristic based on the sensor signal comprises:
determining one or more of a geographic location of the spillage of material out of a material receptacle of a mobile machine based on the sensor signal and location data indicative of a location of the mobile machine at the time the characteristic was detected and a location of the spillage of material out of the material receptacle relative to the mobile machine based on the sensor signal and arrangement characteristics of the material spill sensor.

19. An agricultural system comprising:
a material spill control system configured to:
obtain one or more sensor signals indicative of one or more material spill characteristics;
determine the one or more material spill characteristics based on the one or more sensor signals; and
generate an action signal to control an action of the agricultural system based on the determination of the one or more material spill characteristics.

20. The agricultural system of claim 19, wherein the one or more material spill characteristics include one or more of:
an occurrence of spillage of material out of a material receptacle of a mobile machine;
a location of the spillage of material out of the material receptacle of the mobile machine; and
an amount of material spilled out of the material receptacle of the mobile machine.
